(19) United States
(12) Patent Application Publication
(10) Pub. No.: US 2015/0317716 A1
(43) Pub. Date: Nov. 5, 2015

(54) METHOD AND APPARATUS FOR CATEGORIZING ITEMS OF CLOTHING AND METHOD AND APPARATUS FOR SELECTING FOOTWEAR HAVING AN IMPROVED FIT

(71) Applicant: Dipl. oec. Dirk Rutschmann, Stuttgart (DE)

(72) Inventor: Dipl. oec. Dirk Rutschmann, Stuttgart (DE)

(21) Appl. No.: 14/424,916

(22) PCT Filed: Aug. 30, 2012
(86) PCT No.: PCT/EP2012/066918

§ 371 Date: Jul. 7, 2015

(51) Int. Cl. G06Q 30/06; G06F 17/50

(52) U.S. Cl. CPC G06Q 30/0627; G06F 17/50

(57) ABSTRACT

A method and a device for categorizing articles of clothing and a method and a device for selecting footwear having an improved fit are specified. A parameter describing the fit and/or the size of an article of clothing is acquired on the basis of a measurement carried out on the article of clothing in question. This measurement is performed for a plurality of articles of clothing of different manufacturers but having an identical manufacturer clothing size, a plurality of different manufacturer clothing sizes being furthermore considered. A frequency analysis for the occurrence of specific values of the at least one parameter is then performed for articles of clothing having an identical manufacturer clothing size. The articles of clothing are categorized by a new allocation of the clothing size, a new clothing size being allocated to the articles of clothing in such a manner that the parameters of the articles of clothing provided with the new clothing size within this new clothing size have a smaller dispersion.

The invention relates to a method and to a device for categorizing articles of clothing. The invention furthermore relates to a method and to a device for selecting footwear having an improved fit.

### TECHNICAL BACKGROUND

For the selection of a fitting shoe, the standardization information of the “shoe size” is usually taken as a basis to find the right size variant for a shoe model. The “shoe size” is intended to describe a complex three-dimensional shoe inner shape and to make the latter comparable. However, since different shoes having the same shoe size information often represent shoe inner shapes having very different forms and also different lengths, the client can use this information merely as very rough approximation. Usually, the client has no other alternative than to classify the fit of a shoe as fitting or not fitting by trying on by trial and error.

While this physical try-on is possible and common in the brick-and-mortar business and merely makes the selection process more difficult and longer, this is in principle no longer possible in the mail-order business, in particular in the purchase of shoes based on the Internet, due to the spatial separation of goods and client. As a result, the Internet buyer often simultaneously orders several shoe sizes/shoe widths and returns the shoes which do not fit at the cost of the mail-order company. In this way, very high costs are incurred by the mail-order company due to the required logistics, the necessary visual check and the new packaging of returns and the new storing. These high costs constitute a considerable charge of this business model otherwise modern and corresponding to the spirit of the times.

The worldwide usual standardization methods for shoes such as the EU, US or UK shoe size, e.g. the so-called Paris point in France or the unit of measurement barleycorn in the Anglo-Saxon region, have been developed to determine the last or shoe inner length in order to describe different shoe shapes and to make them comparable with each other. Further shoe size systems are for the most part derived from the mentioned systems. As consistent systems are involved, they may be converted into each other using conversion tables.

In these conventional standardization methods, the complex three-dimensional shape of the shoe interior is described by means of a one-dimensional linear dimension. To this end, three reference values are in particular used in practically all shoe size systems:
the length of the shoe last is measured, which is a production mould and fills the shoe interior during manufacture,
the length of the shoe interior is measured,
conclusions are empirically drawn about the shoes to be standardized by means of so-called test runners the foot length of which is measured. These foot lengths are used as shoe sizes depending on which shoes fit the test runners with a known foot length.

These standardization methods with their historically and regionally different origins differ in the unit of measurement used and the zero point for the determination of the length.

The traditional shoe size systems are characterized in that
units of length and appropriate intervals are fixed, wherein the latter is for example 6.66 mm in a EU shoe size,
these units of length can be converted into each other,
the systems are now widely used, and
a wide practical knowledge in dealing with these systems is available.

These shoe size systems as standardization methods however have the drawback that they are not standardized and not clearly described, in particular:
that with respect to the object to be measured (last, shoe interior or feet),
the measuring points of the linear dimension are not clearly defined,
they do not explicitly take the so-called functional or fashionable additions into account, which are added to the toe region to facilitate the dynamic movement or are added for fashionable reasons so as to modify the length,
different units of measurement prevail on the market under the same name, such as in the US shoe size system in which in particular the big sports shoe manufacturers often use 10 mm as scaling instead of half a barleycorn (approx. 8.466 mm),
the relatively complex three-dimensional inner shape of the shoe is reduced to very few dimensions, in most cases only to the length, by means of a strong simplification,
inaccuracies are produced by rounding to half or full sizes upon conversion from one to another sizing system, and
the standardization, i.e. the definition of the shoe size of a specific model is performed by the respective manufacturer himself and in very different ways.

Due to these limitations of the used standardization methods for shoe sizes, shoes are today offered on a large scale on the market, which have shoe inner shapes that differ considerably despite identical shoe size designations.

There have been many attempts to improve the selection of a fitting shoe size of a desired shoe model by the client. The processes and methods can be subdivided into the two following approaches:

approach a): the individual comparison between the foot of the client and the shoe models offered,

approach b): the numerical description of feet and shoes by means of “shoe sizes” or other categories, and the assignment thereof in classes.

An illustrative example for approach a) is the method used in the Internet shop for children's shoes of “Ricosta” of Donaueschingen (cf. also: www.ricosta.de/ricosta-welt/fussmessung-online). Here, for the purpose of a graphical-visual comparison, the naked child's foot is placed on or held in front of the flat screen of the client's Internet computer. A single geometric calibration is previously carried out on the computer screen using a calibration aid. A template of a schematic sole the length and the width of which can be modified using the mouse is than represented on the screen. The client can modify the approximate length and width of the schematic sole of the child's foot represented on the screen by means of two slide controls, and can determine the length and width of the child's foot by a purely visual comparison with the child's foot present in front of the screen. These specifications are used for the ensuing order. Due to this direct comparison, this method does in principle not require further details such as the shoe size.

Also the formerly common methods of X-ray observation of the foot skeleton within a shoe put on can be classified under approach a). These methods are however no longer used due to the high radiation exposure. There are alternative approaches to visually represent the position and shape of the foot within the shoe using passive thermal imaging cameras so that no damaging radiation exposure occurs (cf. for example U.S. Pat. No. 6,975,232 B1).

Several further method variants also exist as to approach a). The foot is for example geometrically measured by means of a measuring device and compared with the geometrical data of the shoe candidates to be considered. These systems are usually classified in two- and three-dimensional foot measuring devices. The selection of fitting shoes is performed by a comparison of the measuring information about the foot (e.g. 2D-sole shape, 3D-foot model, etc.) with the available geometric measurement data of the lasts used for the manufacture or the measured shoe interiors.

The Canadian company Vorum Research Corporation offers a 3D-comparison between the foot and the shoe (cf. also www.vorum.com/english/footware/matching-system.php). The entire surface of a foot is statically measured using a three-dimensional foot scanner and is then compared with the available three-dimensional last information and is evaluated with respect to its fit.

The second approach b) relates to the conventional approaches as to the classification of feet and shoes by means of a standardized shoe size. This approach proceeds on the assumption that knowing the shoe size, the assignment of a fitting shoe model via a categorization is simple.

Examples for this classical approach b) are the established shoe size systems described above, such as the US, UK or EU shoe size systems. In case the shoe size is unknown, the length and partially the width of feet are measured using simple means (measuring tape, Brannock vernier caliper, etc.) to assign a shoe size and a width to them. All shoe models labeled with shoe size 42 should fit a foot having the standard size 42, which is however often not the case in practice.

It remains to note that the approaches a) and b) are satisfactory neither with regard to the obtainable fitting quality, nor with regard to the simple handling desired by the client. In particular in the mail-order business where it is not possible to try the footwear on, erroneous fits and extremely costly returns of the goods therefore often occur.

### SUMMARY

The object of the invention is to specify a device and a method which reduce the difficulties existing in the prior art.

According to one aspect of the invention, a method of categorizing articles of clothing with regard to their clothing size is specified. This clothing size, for example a dress size for outer clothing or a shoe size for shoes, describes a fit and/or a size of the article of clothing. Each article of clothing is provided with a specific manufacturer clothing size on the part of the manufacturer. Within the context of the method according to the invention, a basic population of articles of clothing is considered which comprises articles of clothing having different manufacturer clothing sizes. Articles of clothing of different manufacturers for each manufacturer clothing size are respectively included in this basic population. First, at least one parameter describing the fit and/or the size of the article of clothing is acquired on an article of clothing from this basic population by means of a measurement performed on the article of clothing concerned. This at least one parameter is assigned to the manufacturer clothing size of the article of clothing concerned. These two steps of detection and assignment are performed for a plurality of articles of clothing having an identical manufacturer clothing size. Articles of clothing of different manufacturers or suppliers are here taken into account. In other words, articles of clothing having the same size but different manufacturers or suppliers are thus analyzed within one manufacturer clothing size. Furthermore, the two steps of detection and assignment are performed for a plurality of articles of clothing having different manufacturer clothing sizes. A frequency analysis is then performed as to the occurrence of specific values of the at least one parameter for such articles of clothing which have an identical manufacturer clothing size but are offered by different manufacturers or suppliers. This frequency analysis is performed for a plurality of manufacturer clothing sizes. In the ideal case, there is then one respective frequency distribution and one frequency analysis for each examined manufacturer clothing size, the frequency analysis being performed on the basic population mentioned which includes articles of clothing of different manufacturers. The articles of clothing are then re-categorized by a new allocation of a new clothing size which may possibly differ from the manufacturer clothing size. The categorization is carried out such that the new clothing size is assigned to the articles of clothing for which the at least one parameter within the newly allocated clothing size has a smaller dispersion than was the case in the original manufacturer clothing size.

In other words, the new allocation of the clothing size is carried out such that the frequency distribution of the at least one parameter overlaps less strongly for neighboring new clothing sizes than was the case for the original manufacturer clothing sizes. In the terminology of statistics and classification, this means that the resulting frequency distribution in the new clothing size has a reduced intra-class variance and an increased inter-class variance. In the present case, the class is the new clothing size.

Advantageously, using the method of categorizing articles of clothing, it is possible to reduce the negative influence on the fit resulting from deviations of fit in identical or similar articles of clothing of different manufacturers which are present despite the same manufacturer clothing size. The consumer can orientate himself/herself towards the newly allocated clothing size instead of the original manufacturer clothing size. This is particularly advantageous for the online mail-order business since in this way, there is a higher probability that the consumer is provided with a fitting article of clothing, and the number of returns can be reduced. At the same time, the consumer can orientate himself/herself on the basis of the familiar clothing size, such as the dress size or the shoe size, e.g. The consumer need not provide further information or take further actions such as a measurement or a visual comparison. Due to the performed re-allocation of the clothing size which constitutes a virtual “re-labeling”, the consumer can be provided with a considerably higher probability with an article of clothing that corresponds to the fit he/she has assumed by experience which is for him/her hidden behind the clothing size indication in question.

In a very simplified illustration, the method according to aspects of the invention is based on the evaluation of the following findings. In modern electronic mail-order business, a specific article of clothing is offered by a large number N of different manufacturers. Despite generally identical geometries, there are relatively great differences between the articles of clothing though they are provided with the same manufacturer clothing size. Typically, N>20 different manufacturers offer a specific article of clothing in the common clothing sizes. The basic population N is large enough to obtain, by measurements, statistically solid findings and systems as to these manufacturer clothing sizes which differ considerably from manufacturer to manufacturer. On the basis of empirical analyses, it could be proved that for one respective specific article of clothing from the production of the N manufacturers with their own respective manufacturer clothing size, the center of a frequency distribution of physically measurable dimensions is near a “real” clothing size. This “real” clothing size corresponds to the fit and size which the client expects from this clothing size. According to aspects of the invention, these findings are used to provide the client with articles of clothing having on average a better fit despite the basically unreliable manufacturer clothing size via a virtual re-labeling, i.e. a re-allocation of the clothing size.

Advantageously, in the method of categorizing articles of clothing, a statistical key figure characterizing the frequency distribution, e.g. a percentile value or a mean vale of the at least one parameter from the respective frequency distribution can be determined for the plurality of manufacturer clothing sizes. In case several parameters are acquired, several statistical key figures are determined from the corresponding frequency distributions. The at least one statistical key figure is assigned to a corresponding new clothing size. Furthermore, it is possible to determine a deviation of the at least one parameter from the corresponding statistical key figure of the parameter for different manufacturer clothing sizes. That new clothing size is assigned to the article of clothing, for which this deviation is minimal.

It is furthermore possible to perform the acquisition of the parameter describing the fit and/or the size on identical or similar articles of clothing of different manufacturers. The parameter(s) may for example be acquired on a specific type of article of clothing, for example a men's jacket or a women's ankle boot of different manufacturers. A categorization may then be performed for all identical or similar articles of clothing of the corresponding manufacturer. In this way, information such as that the men's low shoe of type A of manufacturer B in shoe size 42 sizes small and rather corresponds as to its inner shape to shoe size 41, can be acquired and used to re-categorize all men's low shoes of type A of manufacturer B and to allocate the new shoe size 41 rather than the manufacturer shoe size 42 to these shoes.

According to a further embodiment, the method relates to the categorization of shoes. The manufacturer clothing size is in this case the manufacturer shoe size defined on the part of the manufacturer. To reduce a negative influence on the fit due to inner shape deviations existing despite identical manufacturer shoe sizes, an inner shape of a shoe can be detected in a first step. This step may for example be performed using a shoe interior scanner. At least one parameter is then determined, which describes the shoe interior dimension. This at least one parameter is assigned to the manufacturer shoe size. These two steps are performed for identical or similar shoe models from the production of different manufacturers and for different manufacturer shoes sizes. A frequency analysis for the occurrence of specific values of the at least one parameter is then performed for shoes of different manufacturers having identical manufacturer shoe sizes. Moreover, frequency analyses are performed for the shoes in the different manufacturer shoe sizes, but for different manufacturers or suppliers. A categorization of the shoes is realized by a new allocation of the shoe sizes, a new shoe size being assigned to the shoes such that the parameters of the shoes provided with the new shoe size within this new shoe size have a smaller dispersion than in the original manufacturer shoe size. The frequency distributions of the parameters of neighboring new shoe sizes overlap less strongly than is the case in the original manufacturer shoe sizes also in that case.

An application of the method of categorizing shoes is particularly advantageous, since there is no standardized and uniform shoe size system for shoes.

According to a further advantageous embodiment, at least one shoe per shoe model, per manufacturer shoe size and per manufacturer is representatively measured for this shoe model, for this manufacturer and for the shoe size thereof using a shoe interior scanner. The parameters describing the shoe interior dimension comprise at least one anatomically relevant quantity. In the context of a frequency analysis performed, a one-dimensional frequency function is formed for the chosen anatomically relevant quantity. A membership function is determined. The latter defines a range of values for the chosen anatomical quantity. Those values characterizing the anatomically relevant quantity which match for the most manufacturers are within this range of values. In other words, a predominant number of the values matching for most manufacturers are within this range of values. The membership function can be fixed on the basis of a threshold value of 50% or 90%, for example. The membership function is assigned to the new shoe size. A categorization of the shoes is then carried out by a new allocation of the shoe size. This re-allocation is carried out such that a new one-dimensional frequency function for shoes within the new shoe size and for all manufacturers considered has a smaller dispersion than the original one-dimensional frequency function.

An anatomically relevant quantity may for example be the interior length, the ball circumference, the big toe angle, the heel height, the height profile of the footbed etc. It is accordingly possible to consider multidimensional frequency distributions.

According to a further embodiment, at least one shoe per shoe model, per manufacturer shoe size and per manufacturer is measured using a shoe interior scanner, n>=2 interior dimensions being extracted from these measurements. An n-dimensional frequency function of the n chosen anatomical quantities is accordingly formed for each shoe size and for all manufacturers. A maximum of this n-dimensional frequency function is determined, and an n-dimensional membership function is fixed which defines that range of values of the n anatomical quantities which matches for most manufacturers for the manufacturer shoe size considered. For the definition of the n dimensional membership function, appropriate limit values may in turn be used, wherein one individual limit value may be determined for each dimension. The show size is then re-determined so that the n interior dimensions within the newly determined shoe size have a smaller dispersion than was the case in the original manufacturer shoe sizes.

Furthermore, the method of categorizing articles of clothing may advantageously be used for protective clothing or medical parts adapted to the body, such as supports, splints or protectors.

A method of selecting footwear having an improved fit is particularly advantageous, in particular with regard to the use in the online mail-order business. In this method according to a further aspect of the invention, the shoes are first re-categorized as to the shoe size in accordance with the method of categorizing articles of clothing. Upon request for a specific shoe size, in particular such footwear is offered to the user the new shoe size of which corresponds to the request of the user. In other words, such footwear is offered to the user, the parameter describing the actual fit of which most likely corresponds to what is assumed behind the shoe size in question. The probability to offer fitting footwear to the user may be increased.

According to a further aspect of the invention, a device for categorizing articles of clothing with regard to their clothing size is specified. The device comprises at least one scanner for acquiring at least one parameter which describes the fit and/or the size of an article of clothing. The device is adapted to consider a basic population which includes articles of clothing having different manufacturer clothing sizes. Articles of clothing of different manufacturers or suppliers in each of the manufacturer clothing sizes are included in this basic population. The device furthermore has a processing unit which is adapted to assign the at least one acquired parameter to the manufacturer clothing size. The processing unit is furthermore adapted to perform a frequency analysis for the occurrence of specific values of the at least one parameter for articles of clothing of different manufacturers which however have an identical manufacturer clothing size. This frequency analysis is moreover performed for a plurality of manufacturer clothing sizes. The articles of clothing are finally categorized by a new allocation of the clothing size. The new clothing size is assigned to the articles of clothing such that the parameters of the articles of clothing provided with the new clothing size within the re-allocated clothing size have a smaller dispersion than within the original manufacturer clothing size.

The device for categorizing articles of clothing according to aspects of the invention is in particular adapted to categorize shoes. In this respect, the scanner is preferably a scanner for acquiring an inner shape of shoes which can furthermore be adapted to determine at least one parameter which describes the shoe interior dimension. This parameter is assigned to the manufacturer shoe size on the part of the processing unit. A frequency analysis for the occurrence of specific values of the at least one parameter is then performed for shoes having an identical shoe size. A categorization of the shoes is carried out by a new allocation of the shoe size, a new shoe size being assigned to the shoes in such a manner that the parameters of the shoes provided with the new shoe size within this new shoe size have a smaller dispersion than in the original manufacturer shoe size.

According to a further aspect of the invention, a device for selecting footwear having an improved fit is specified. It comprises a device for categorizing articles of clothing according to aspects of the invention and furthermore an input unit and an output unit. The input unit is adapted to receive information about a shoe size desired by a user. The processing unit is adapted to offer the user information about footwear the new shoe size of which corresponds to the shoe size desired by the user via the output unit.

Identical and similar advantages as already mentioned with regard to the method according to aspects of the invention are also applicable in an identical or similar manner to the devices according to aspects of the invention and are therefore not repeated here.

### SHORT DESCRIPTION OF THE DRAWINGS

The invention will be described in detail below with reference to the drawings illustrating preferred example embodiments, in which:

FIG. 1 shows a frequency distribution of the shoe inner length for women's ankle boots of different manufacturers and different manufacturer shoe sizes,

FIG. 2 shows selected frequency distributions (FIG. 2A) and the membership functions thereof (FIG. 2B),

FIG. 3 shows a two-dimensional frequency distribution for a shoe inner length and a ball circumference for women's ankle boots of different manufacturers and different manufacturer shoe sizes, and

FIG. 4 shows individual measuring points of the frequency distribution of FIG. 3 in a 2D-plot (FIG. 4A), the determination of membership functions using methods of clustering (FIG. 4B), and a schematic illustration of a subsequent re-allocation of shoe sizes on the basis of a statistical analysis of the determined frequency distributions (FIG. 4C).

### DETAILED DESCRIPTION

The realization of a method according to one example embodiment is to be described below as an example for the shoe model “women's ankle boot”. To the time of the analysis, the type of shoe was offered in an Internet shop by 51 different manufacturers in different sizes and design variants. The extensive studies of the interior dimensions have been performed on 874 shoes using a shoe interior scanner working in an optical and non-destructive manner, which is for example described in document WO 2009/006989 A1. The measurements have shown that the same shoe model manufactured by different shoe manufacturers has very different shoe inner lengths for an identical manufacturer size indication, i.e. a labeled shoe size. By way of alternative to the explicit measurement, it is also possible to grade the required interior dimensions from neighboring measured sizes of the same shoe models as far as reliable grading methods exist for the shoe models concerned.

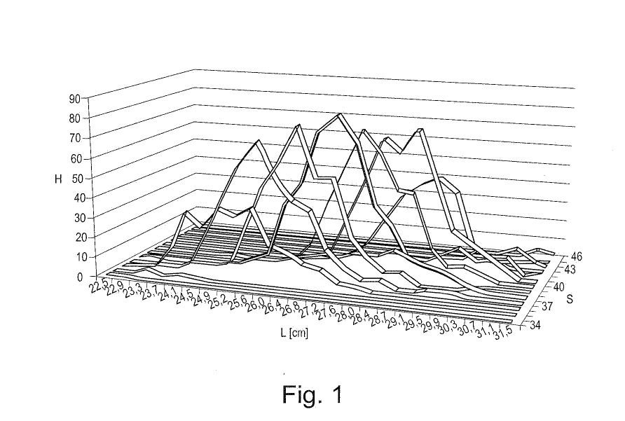

FIG. 1 shows a frequency distribution of the shoe inner lengths L measured by means of the interior scanner for women's ankle boots in shoe sizes S from EU 36 to EU 41, manufactured by 36 different shoe makers. The dispersion of frequency H of the measured shoe inner lengths L differs for the different manufacturers by up to three EU-shoe sizes. In these examinations, it could furthermore be observed that compared with the unsystematic labeling of the different manufacturers, the actual production tolerances are negligible. Difficulties in terms of fit are largely due to imprecise manufacturer size indications. With this respect, it is possible according to a further example embodiment to measure a shoe in a representative way for a shoe size of a specific manufacturer and to assume a same or identical parameter for the appropriately labeled shoes of this manufacturer. In other words, it can be assumed that all shoes of a specific type, a specific manufacturer shoe size and a specific manufacturer have an approximately identical shoe inner length L.

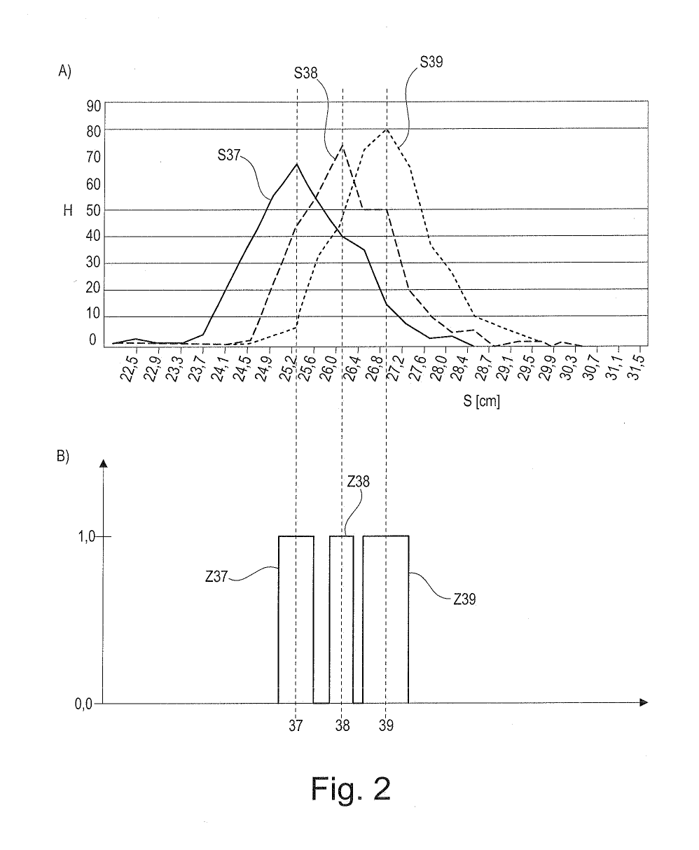

FIG. 2A shows the distribution of the frequency H of the shoe inner length L of the women's ankle boots for the three shoe sizes EU 37 (curve S37), EU 38 (curve S38) and EU 39 (curve S39) for shoes of different manufacturers. The frequency distributions S37, S38, S39 clearly overlap, the measured shoe inner length S is scattered over several neighboring shoe sizes. One respective binary membership function can be determined from the one-dimensional frequency distribution for each of the shoe sizes. This is shown in FIG. 2B. Z37 refers here to the membership function for shoe size EU 37, Z38 to the membership function for shoe size EU 38, and Z39 to the membership function for shoe size EU 39. The center of the membership functions Z37, Z38, Z39 can be determined on the basis of the center of the corresponding frequency distributions S37, S38 and S39, respectively, and can be centered on the maximum value of the respective frequency distribution S37, S38, S39.

The width of the membership functions Z37, Z38, Z39 which may be identical for all membership functions, may be chosen such that the shoe inner lengths L of the appropriate shoe size occurring most frequently are within the membership function Z37, Z38, Z39. The width of the membership function Z37, Z38, Z39 may for example be chosen such that at least 50% or 90% of the shoes of the appropriate shoe size are within the respective membership function. The width of the membership functions Z37, Z38, Z39 and the limit value can of course be fixed arbitrarily and on the basis of the respectively measured distribution of the frequency H. It is possible to determine such a membership function for each manufacturer shoe size offered. The new shoe size 37 now comprises for example all shoe inner lengths L of 23.7 cm (left border) up to the middle of the interval between the membership function Z37 and Z38 of the new shoe size 38, 26.0 cm in the example. The new shoe size 38 includes shoe inner lengths L of 26.1 cm up to 26.8 cm, and the new shoe size 39 includes shoe inner lengths L of 26.9 cm up to 30.7 cm.

A new allocation of the shoe sizes is then carried out. On the basis of the measured shoe inner lengths L, outliers of the respective neighboring shoe size are assigned, the designation of the manufacturer shoe sizes, i.e. EU 37, EU 38 etc. for example, being maintained as categories of this new categorization. Due to this virtual re-labeling of the shoes which can for example be carried out using an appropriate database, the shoe inner lengths L within the new shoe sizes are homogenized, wherein the overlapping of the frequency distributions of neighboring shoe sizes is reduced.

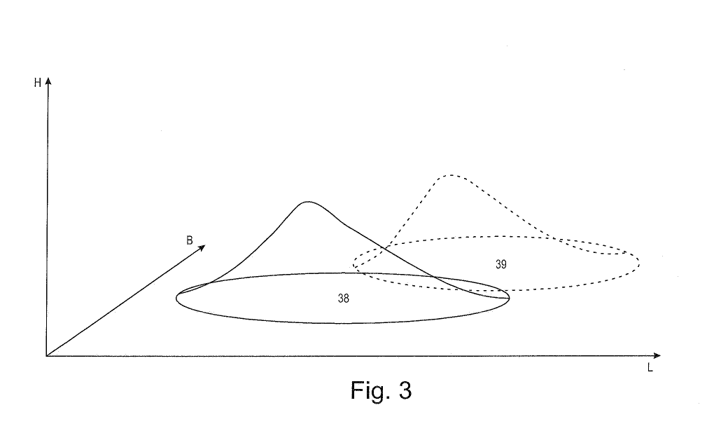

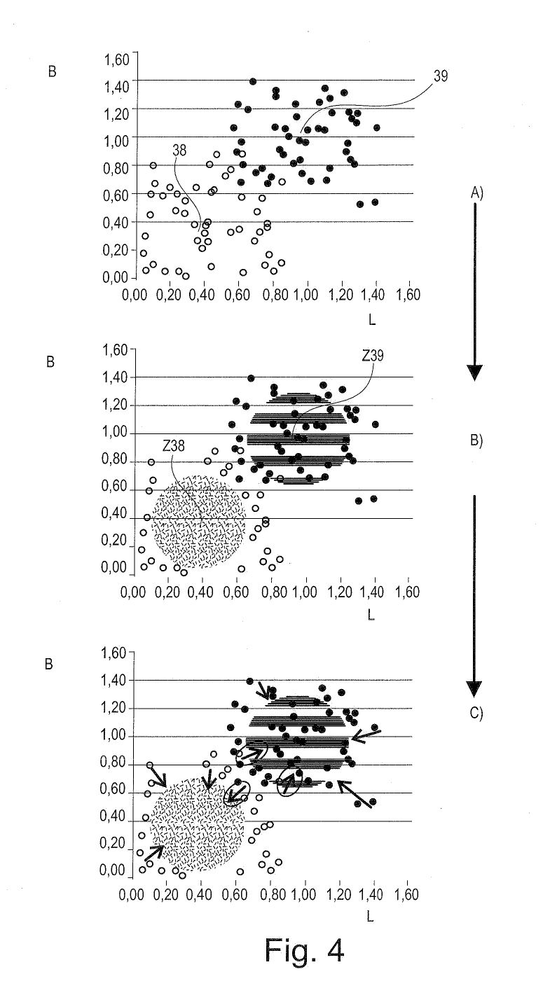

FIG. 3 shows a two-dimensional frequency distribution for two anatomically relevant quantities, namely the shoe inner length L and the ball circumference B. The frequency H is represented in a 2D-plot for shoe sizes EU 38 and EU 39. According to one example embodiment, a method of categorizing the appropriate shoes using this two-dimensional frequency distribution is to be explained with reference to FIG. 4.

FIG. 4A shows the individual measurement results for the shoe inner length L and the ball circumference B in a scatter diagram, i.e. the projection of the 2D-histogram on a base area. Each point entry corresponds to the inner dimension pair composed of the shoe inner length L and the ball circumference B of an ankle boot of the shoe sizes considered and for one of the 51 manufacturers considered by way of example. The pairs of values for the manufacturer shoe size EU 38 are illustrated by open circles, those for the manufacturer shoe size EU 39 by closed circles. The large scattering and overlapping of the frequency distributions are clearly visible. For reasons of clarity, the representation is limited to two manufacturers and to shoe sizes EU 38 and EU 39. In FIG. 4B, two-dimensional membership regions Z38 and Z39 have been defined for each shoe size EU 38 and EU 39 on the basis of the pairs of values occurring most frequently of the shoe inner length L and the ball circumference B. The membership regions Z38 and Z39 are chosen in the form of circles by way of example. Any further appropriate shape for the membership regions Z38, Z39 is of course possible.

A categorization of the shoes may then be carried out. This is shown in FIG. 4C. The new shoe sizes can be assigned to the shoes using the membership regions such that the resulting frequency distribution in these new shoe sizes shows a reduced intra-class variance and an increased inter-class variance. In this context, the shoe size is considered as a class. This may be obtained in two agglomeration steps. The shoe size is maintained for all pairs of values within a membership region. The pairs of values outside the membership region are assigned to the next membership regions and, if necessary, are re-allocated. All pairs of values designated by a not circled arrow are assigned to a new shoe size corresponding to the previous manufacturer shoe size. The pairs of values designated by an encircled arrow are assigned to a new shoe size which differs from the original manufacturer shoe size. The assignment of the new shoe size can for example be performed by calculating a distance between the pair of values and a center or maximum (cf. also FIG. 3) of the neighboring shoe sizes. The corresponding pair of values is now assigned to that shoe size from which the distance is the smallest.

A skilled person in the field of statistics and in particular of cluster analysis and classification knows to add further inner dimensions anatomically relevant to the fit, such as the big toe angle, the heel height, the height profile of the footbed etc. to the inner shape parameters such as shoe inner length L and the ball circumference B, and to evaluate the described frequency functions in appropriately higher dimensional value spaces.

With a device for categorizing articles of clothing according to a further example embodiment, the re-allocation of the shoe size as described above may be carried out automatically, wherein the manufacturer shoe sizes of different manufacturers are “virtually re-labeled” using a database, for example. This is particularly advantageous for the online mail-order business, as explained by way of example below.

A female client orders a pair of women's ankle boot at the mail-order business. She knows her usual shoe size (for example EU 38) from former orders or from her fitting footwear. The mail-order company offers women's ankle boots of different manufacturers. They may differ for the same labeled shoe size in material, color, fashion accessories, price etc. The client desires to order a fitting shoe according to shoe size EU 38 from this range of goods. The shoe sizes used by the manufacturers are very different due to the labeling characteristics of the respective manufacturers or of the last manufacturers thereof. Due to the already performed categorization, the mail-order company however knows that for the different manufacturers the labeled manufacturer shoe size EU 38 may be very different with regard to the actual shoe shape and the interior dimensions thereof. Therefore, many difficulties as to the fit must be expected if the client orders a model merely in accordance with her search criterion “shoe size EU 38”.

According to an example embodiment, the mail-order company however has geometrically measured all women's ankle boots of its different manufacturers using a 3D-interior scanner and has determined on this basis a statistic (for all manufacturers) of the actually occurring inner shapes for each labeled manufacturer shoe size. The inner shape of the shoes is preferably described by the manufacturer using dimensions such as the shoe inner length L, the ball circumference B etc. The supplier thus has a frequency distribution comparable with that of FIG. 1, 2A or 3.

According to the invention, these histograms of the shoe inner lengths L are used as follows: The regions about the maxima are the shoe inner lengths L for a given shoe size (for all manufacturers) occurring most frequently. When selecting a shoe on the basis of the highly scattering manufacturer shoe size, the probability for the ordering client is the highest to encounter a shoe inner length L in the region of the histogram maximum. These regions of maximum frequency are thus defined as region of the shoe inner length L in which the standards shoe size of the client is most likely to match with the shoe size labeled by the manufacturer. Shoe inner lengths L outside these regions of maximum frequency are virtually re-labeled in neighboring shoe sizes by the mail-order company, and these re-labeled sizes are used for the selection of the best fitting shoe.

A particular advantage of the method consists in that the expenditure on the part of the ordering client is not increased despite the improvement of the obtainable fit rate. The client does not require any additional anatomical features of his/her foot beyond the classical shoe size. The efforts to be made remain to the mail-order company, which can integrate the method according to the invention in its electronic ordering procedure.

It is left to the mail-order company whether it communicates the performed categorization to the client, for example by specifications such as: “We recommend you for your shoe size “38” and this manufacturer “X” to order a shoe size “39””, or if the selection of the fitting shoe with the re-labeled shoe sizes remains invisible for the buyer.

The method according to aspects of the invention is not limited to the mail-order business of shoes. It may also be advantageously applied to the conventional shoe selling, i.e. in the shoe shop to reduce the number of potentially fitting shoes prior to the actual trying on and thus to accelerate the selling process. The allocation of the shoe sizes can be carried out by means of a database on site or by means of an outsourced database, an assignment table e.g., and positively limit the choice of possibly fitting shoes.

The method according to aspects of the invention is not limited to the selection of footwear, but may also be applied advantageously in a similar manner to the clothing commerce. Also here, the problem is known that manufacturer clothing sizes are assigned in an unsystematic manner, vary and are little consistent with standard sizes. Instead of a shoe interior scanner, a body scanner may be used to determine the frequency distributions of the different body dimensions such as waist circumference, length of leg, chest measurement etc. Using the method according to the invention, a considerably smaller dispersion within the newly allocated clothing size and a considerably reduced overlapping between the different clothing sizes may be obtained.

1: A method of categorizing articles of clothing with regard to their clothing size describing a fit and/or a size of the article of clothing, each article of clothing being provided with a manufacturer clothing size determined on the part of the manufacturer, a basic population being considered which comprises articles of clothing having different manufacturer clothing sizes, and articles of clothing of different manufacturers being included in each manufacturer clothing size, the method comprising the following steps:
a) acquiring at least one parameter describing the fit and/or the size of an article of clothing on the basis of a measurement carried out on the article of clothing concerned,
b) assigning the acquired parameter to the manufacturer clothing size of the measured article of clothing,
c) performing the steps a) and b) for a plurality of articles of clothing of different manufacturers having an identical manufacturer clothing size,
d) performing the steps a) to c) for a plurality of different manufacturer clothing sizes,
e) performing a frequency analysis for the occurrence of specific values of the at least one parameter for articles of clothing of different manufacturers having an identical manufacturer clothing size, the frequency analysis being performed for a plurality of manufacturer clothing sizes,
f) categorizing the articles of clothing by a new allocation of the clothing size, the new clothing size being allocated to the articles of clothing in such a manner that the at least one parameter of articles of clothing provided with the new clothing size within this new clothing size has a smaller dispersion than the at least one parameter acquired as to the manufacturer clothing size.

2: The method of categorizing articles of clothing according to claim 1, wherein a statistical key figure characterizing the frequency distribution for the at least one parameter from the respective frequency distribution is determined for each of the manufacturer clothing sizes considered and is allocated thereto, and wherein in step f), a deviation of the at least one parameter of an article of clothing to be categorized from the corresponding statistical key figure of this parameter for articles of clothing of different manufacturers and having different manufacturer clothing sizes is determined, and wherein that new clothing size is allocated to the article of clothing, for which the deviation from the statistical key figure is minimal.

3: The method of categorizing articles of clothing according to claim 2, wherein the statistical key figure characterizing the frequency distribution is a percentile value of the frequency distribution and/or a mean value of the frequency distribution.

4: The method of categorizing articles of clothing according to claim 1, wherein step a) is performed on identical or similar articles of clothing of different manufacturers, at least one article of clothing being respectively measured representatively for a manufacturer clothing size of a manufacturer considered, and wherein in step f), a categorization is carried out for all articles of clothing of the considered manufacturer clothing size of the corresponding manufacturer.

5: The method of categorizing articles of clothing according to claim 1, wherein the articles of clothing are shoes and the manufacturer clothing size is a manufacturer shoe size assigned on the part of the manufacturer, wherein, to reduce a negative influence on the fit as a result of inner shape deviations despite an identical manufacturer shoe size,
in step a), an inner shape of a shoe is acquired and at least one parameter describing the dimension of the shoe interior is determined,
in step b), the at least one parameter of the manufacturer shoe size is assigned,
steps a) and b) are performed for identical or similar shoe models from the production of different manufacturers and for different manufacturer shoe sizes,
in step e), a frequency analysis for the occurrence of specific values of the at least one parameter is performed for shoes of different manufacturers but having an identical manufacturer shoe size, and
in step f), a categorization of the shoes is performed by a new assignment of the shoe size, the new shoe size being allocated to the shoes such that the at least one parameter of the shoes provided with the new shoe size within the new shoe size has a smaller dispersion than in the original manufacturer shoe size.

6: The method of categorizing articles of clothing according to claim 5, wherein
in step a), at least one shoe per shoe model and per manufacturer shoe size is measured in a representative manner for the shoe model and the manufacturer shoe size using a shoe interior scanner, and at least one anatomically relevant quantity is acquired as parameter describing the dimension of the shoe interior,
in step e), a one-dimensional frequency function is formed for the chosen anatomically relevant quantity,
a membership function is fixed, which defines a range of values of the anatomically relevant quantity in question, and this membership function is allocated to a new shoe size, and
in step f), a categorization of the shoes is performed by a new allocation of the shoe size, such that the one-dimensional frequency function of the parameter describing the anatomically relevant quantity within the new shoe size has a smaller dispersion than in the original manufacturer shoe size.

7: The method of categorizing articles of clothing according to claim 5, wherein
in step a), at least one shoe per shoe model and per manufacturer shoe size is measured using a shoe interior scanner, and n>=2 interior dimensions are extracted from these measurements,
in step d), an n-dimensional frequency function per shoe size and per manufacturer is established for the n chosen anatomical quantities,
an n-dimensional membership function is fixed which defines a range of values of the n anatomical quantities, and
in step f), the shoe sizes for all manufacturers considered are reallocated such that the n interior dimensions within the new shoe sizes have a smaller dispersion than in the original manufacturer shoe sizes.

8: The method of categorizing articles of clothing according to claim 1, wherein the articles of clothing are protective clothing or medical parts adapted to the body, such as supports, splints or protectors.

9: A method of selecting footwear having an improved fit, wherein shoe sizes are reassigned in accordance with a categorizing method according to claim 5, and wherein shoes the new shoe size of which corresponds to the request of the user are offered to a user on request for a specific shoe size.

10: A device for categorizing articles of clothing with regard to their clothing size which describes a fit and/or a size of the article of clothing, each article of clothing being provided with a manufacturer clothing size determined on the part of the manufacturer, and wherein a basic population is considered which comprises articles of clothing having different manufacturer clothing sizes and articles of clothing of different manufacturers are included in each manufacturer clothing size, and wherein the device comprises a scanner for acquiring at least one parameter describing the fit and/or the size of an article of clothing, and a processing unit, the processing unit being adapted
a) to assign the at least one acquired parameter to the manufacturer clothing size,
b) to perform a frequency analysis for the occurrence of specific values of the at least one parameter for articles of clothing of different manufacturers having an identical manufacturer clothing size, and to perform the frequency analysis for a plurality of articles of clothing of different manufacturers but having an identical manufacturer clothing size, and for different manufacturer clothing sizes, and
c) to categorize the articles of clothing by a new allocation of the clothing size and to allocate the new clothing size to the articles of clothing such that the at least one parameter of the articles of clothing provided with the new clothing size within the new clothing size has a smaller dispersion than in the original manufacturer clothing size.

11: The device for categorizing articles of clothing according to claim 10, wherein the articles of clothing are shoes and the manufacturer clothing size is a manufacturer shoe size assigned on the part of the manufacturer, and wherein the scanner is a scanner for detecting an inner shape of shoes and is further adapted to determine at least one parameter describing the dimension of the shoe interior, and the processing unit being further adapted:
in feature a), to assign the at least one parameter to the manufacturer shoe size,
in feature b), to perform a frequency analysis for the occurrence of specific values of the at least one parameter for shoes of different manufacturers having an identical manufacturer shoe size, and
in feature c), to carry out a categorization of the shoes by a new allocation of the shoe size, wherein a new shoe size is allocated to the shoes in such a manner that the at least one parameter of the shoes provided with the new shoe size within the new shoe size has a smaller dispersion than in the original manufacturer shoe size.

12: A device for selecting footwear having an improved fit, comprising a device for categorizing articles of clothing according to claim 11 and an input and output unit, the input unit being adapted to receive information about a shoe size requested by a user, and the processing unit being adapted to offer the user information about footwear the new shoe size of which corresponds to the shoe size requested by the user via the output unit.

13: A method of selecting footwear having an improved fit, wherein shoe sizes are reassigned in accordance with a categorizing method according to claim 6, and wherein shoes the new shoe size of which corresponds to the request of the user are offered to a user on request for a specific shoe size.

14: A method of selecting footwear having an improved fit, wherein shoe sizes are reassigned in accordance with a categorizing method according to claim 7, and wherein shoes the new shoe size of which corresponds to the request of the user are offered to a user on request for a specific shoe size.
